(19) United States
(12) Patent Application Publication
(10) Pub. No.: US 2026/0164405 A1
(43) Pub. Date: Jun. 11, 2026

(54) USER EQUIPMENT RELAY PAGING COORDINATION

(71) Applicant: QUALCOMM Incorporated, San Diego, CA (US)

(72) Inventors: Ahmed BEDEWY, Hillsborough, NJ (US); Naeem AKL, Bridgewater, NJ (US); Navid ABEDINI, Basking Ridge, NJ (US); Jianghong LUO, Skillman, NJ (US)

(21) Appl. No.: 18/971,550

(22) Filed: Dec. 6, 2024

(51) Int. Cl. H04W 68/02

(52) U.S. Cl. CPC H04W 68/02

(57) ABSTRACT

Various aspects of the present disclosure generally relate to wireless communication. In some aspects, a first user equipment (UE) may receive, from a network node, a paging collaboration configuration that associates a first paging occasion with the first UE and a second paging occasion with a second UE. The first UE may receive, in accordance with the paging collaboration configuration, a first paging request associated with the second UE during the first paging occasion. The first UE may transmit the first paging request to the second UE. Numerous other aspects are described.

### FIELD OF THE DISCLOSURE

Aspects of the present disclosure generally relate to wireless communication and specifically relate to techniques, apparatuses, and methods associated for a user equipment relay paging collaboration.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a first user equipment (UE) for wireless communication. The first UE may include one or more memories and one or more processors coupled to the one or more memories. The one or more processors may be configured to receive, from a network node, a paging collaboration configuration that associates a first paging occasion with the first UE and a second paging occasion with a second UE. The one or more processors may be configured to receive, in accordance with the paging collaboration configuration, a first paging request associated with the second UE during the first paging occasion. The one or more processors may be configured to transmit the first paging request to the second UE.

Some aspects described herein relate to a paging UE for wireless communication. The paging UE may include one or more memories and one or more processors coupled to the one or more memories. The one or more processors may be configured to receive, from a network node, a paging collaboration configuration that associates a first paging occasion with the paging UE and a second paging occasion with a relay UE. The one or more processors may be configured to operate in a low-power mode on the first paging occasion. The one or more processors may be configured to receive, from the relay UE and after the first paging occasion, a first paging request in accordance with the paging collaboration configuration. The one or more processors may be configured to transmit, to the network node, a response to the first paging request.

Some aspects described herein relate to a network node for wireless communication. The network node may include one or more memories and one or more processors coupled to the one or more memories. The one or more processors may be configured to output, to a first UE and to a second UE, a paging collaboration configuration. The one or more processors may be configured to transmit, to the second UE, a first paging request associated with the first UE. The one or more processors may be configured to receive, from the first UE, a response to the first paging request.

Some aspects described herein relate to a method of wireless communication performed by a first UE. The method may include receiving, from a network node, a paging collaboration configuration that associates a first paging occasion with the first UE and a second paging occasion with a second UE. The method may include receiving, in accordance with the paging collaboration configuration, a first paging request associated with the second UE during the first paging occasion. The method may include transmitting the first paging request to the second UE.

Some aspects described herein relate to a method of wireless communication performed by a paging UE. The method may include receiving, from a network node, a paging collaboration configuration that associates a first paging occasion with the paging UE and a second paging occasion with a relay UE. The method may include operating in a low-power mode on the first paging occasion. The method may include receiving, from the relay UE and after the first paging occasion, a first paging request in accordance with the paging collaboration configuration. The method may include transmitting, to the network node, a response to the first paging request.

Some aspects described herein relate to a method of wireless communication performed by a network node. The method may include outputting, to a first UE and to a second UE, a paging collaboration configuration. The method may include transmitting, to the second UE, a first paging request associated with the first UE. The method may include receiving, from the first UE, a response to the first paging request.

Some aspects described herein relate to a non-transitory computer-readable medium that stores a set of instructions for wireless communication by a first UE. The set of instructions, when executed by one or more processors of the first UE, may cause the first UE to receive, from a network node, a paging collaboration configuration that associates a first paging occasion with the first UE and a second paging occasion with a second UE. The set of instructions, when executed by one or more processors of the first UE, may cause the first UE to receive, in accordance with the paging collaboration configuration, a first paging request associated with the second UE during the first paging occasion. The set of instructions, when executed by one or more processors of the first UE, may cause the first UE to transmit the first paging request to the second UE.

Some aspects described herein relate to a non-transitory computer-readable medium that stores a set of instructions for wireless communication by a paging UE. The set of instructions, when executed by one or more processors of the paging UE, may cause the paging UE to receive, from a network node, a paging collaboration configuration that associates a first paging occasion with the paging UE and a second paging occasion with a relay UE. The set of instructions, when executed by one or more processors of the paging UE, may cause the paging UE to operate in a low-power mode on the first paging occasion. The set of instructions, when executed by one or more processors of the paging UE, may cause the paging UE to receive, from the relay UE and after the first paging occasion, a first paging request in accordance with the paging collaboration configuration. The set of instructions, when executed by one or more processors of the paging UE, may cause the paging UE to transmit, to the network node, a response to the first paging request.

Some aspects described herein relate to a non-transitory computer-readable medium that stores a set of instructions for wireless communication by a network node. The set of instructions, when executed by one or more processors of the network node, may cause the network node to output, to a first UE and to a second UE, a paging collaboration configuration. The set of instructions, when executed by one or more processors of the network node, may cause the network node to transmit, to the second UE, a first paging request associated with the first UE. The set of instructions, when executed by one or more processors of the network node, may cause the network node to receive, from the first UE, a response to the first paging request.

Some aspects described herein relate to an apparatus for wireless communication. The apparatus may include means for receiving, from a network node, a paging collaboration configuration that associates a first paging occasion with a first UE and a second paging occasion with a second UE. The apparatus may include means for receiving, in accordance with the paging collaboration configuration, a first paging request associated with the second UE during the first paging occasion. The apparatus may include means for transmitting the first paging request to the second UE.

Some aspects described herein relate to an apparatus for wireless communication. The apparatus may include means for receiving, from a network node, a paging collaboration configuration that associates a first paging occasion with a paging UE and a second paging occasion with a relay UE. The apparatus may include means for operating in a low-power mode on the first paging occasion. The apparatus may include means for receiving, from the relay UE and after the first paging occasion, a first paging request in accordance with the paging collaboration configuration. The apparatus may include means for transmitting, to the network node, a response to the first paging request.

Some aspects described herein relate to an apparatus for wireless communication. The apparatus may include means for outputting, to a first UE and to a second UE, a paging collaboration configuration. The apparatus may include means for transmitting, to the second UE, a first paging request associated with the first UE. The apparatus may include means for receiving, from the first UE, a response to the first paging request.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example associated with a discontinuous reception (DRX) cycle with user equipment (UE) paging, in accordance with the present disclosure.

FIG. 4 is a diagram illustrating an example associated with collaborative paging, in accordance with the present disclosure.

FIG. 5 is a diagram illustrating an example associated with UE collaboration for sidelink paging, in accordance with the present disclosure.

FIG. 6 is a diagram illustrating an example associated with paging collaboration, in accordance with the present disclosure.

FIG. 7 is a diagram illustrating an example associated with paging collaboration for DRX, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a paging UE or an apparatus of a paging UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE)-to-network node (U2N) relay refers to a UE that operates as an in-network relay. For example, the U2N relay may serve as a communication intermediary for other UEs. The U2N relay may enable the communication between one or more UEs and the network by relaying signals between the network node and the UEs.

Paging is a wireless communication procedure that allows a network node to notify a UE of an incoming communication or system message intended for the UE. Paging may involve the transmission of a paging request and a paging message from the network node to the UE. Paging may occur when the UE is operating in a low-power state, such as a radio resource control (RRC) idle or RRC inactive state, and may cause the UE to transition the UE into a connected state (e.g., an RRC connected state).

A paging occasion may be a specific time interval during which a UE may monitor a control channel for the paging message. The paging occasion may be determined based on various parameters, including a UE-specific identifier, a system-wide timing configuration, or a predetermined paging cycle. The paging occasion may define when the UE activates a receiver to listen for a paging message, and the paging occasion may be scheduled to minimize power consumption by limiting the active periods of the UE in idle or inactive states.

The paging request may be a signal transmitted by a network node to initiate paging of the UE. The paging request may include information identifying the UE to be paged, such as a UE identifier, and may indicate the purpose of the paging, such as a system update or an incoming communication. The paging request may be transmitted over a control channel and may trigger the transmission of a paging message during a paging occasion associated with the UE.

A paging frame may be a specific time interval in a wireless communication system during which a paging message may be transmitted by the network element to the UE. The paging frame may be determined in accordance with a network configuration and/or one or more parameters. The paging frame may be repeated periodically in accordance with a defined paging cycle. The paging frame may include of multiple time slots, and each time slot may correspond to a paging occasion during which the UE may monitor for a paging message. The paging frame may be coordinated with other timing structures in the wireless communication system to ensure efficient communication between the network and the UE.

Discontinuous reception (DRX) may be a technique used by a UE to reduce power consumption by periodically cycling between active and inactive states while monitoring for network communications. DRX may involve an inactive cycle during which the UE powers down a receiver and ceases to monitor the network, followed by an active cycle during which the UE listens for control messages, such as paging signals. DRX parameters, including the length of active and inactive cycles, may be determined by the network or predefined in accordance with a communication profile or service requirement of the UE.

With respect to DRX, the longer the UE stays in the sleep cycle, the more likely it is that the UE will miss a paging request. If the UE misses a paging request while in an inactive state, the network node will have to wait to resend the paging request in a paging frame of a subsequent DRX cycle, when the UE is operating in an active state. Waiting for the subsequent DRX cycle increase latency. One way to reduce latency is to shorten the amount of time the UE spends in the inactive state. Doing so, however, increases power consumption because the UE consumes more power while operating in the active state than in the inactive state. Accordingly, reducing latency caused by missed paging requests comes at a cost of increased power consumption. Similarly, reducing power consumption can result in increased latency.

Various aspects relate generally to UE paging collaboration. Some aspects more specifically relate to multiple UEs relaying paging requests to one another. In some aspects, the first UE may receive a paging request, intended for the second UE, during a first paging occasion intended for the first UE. In some aspects, the first UE may receive, from a network node, a paging collaboration configuration that associates the first paging occasion with the first UE and a second paging occasion with the second UE. The first UE may receive, in accordance with the paging collaboration configuration, a first paging request associated with the second UE during the first paging occasion; and transmit the first paging request to the second UE. In some aspects, the second UE may be operating in a low-power mode (e.g., a DRX inactive state) during the first paging occasion and receive the paging request, from the first UE, after the second UE transitions to an active mode (e.g., a DRX active state).

Particular aspects of the subject matter described in this disclosure can be implemented to realize one or more of the following potential advantages. In some examples, the described techniques can be used to allow multiple UEs to collaborate to receive paging messages for one another. By collaborating to receive paging messages, the UEs can take turns monitoring paging requests for one another. When a UE is not monitoring for paging requests, the UE can spend a longer period of time in the DRX inactive state. Accordingly, by collaborating with multiple UEs to receive paging messages, power consumption can be reduced without significantly increasing latency.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

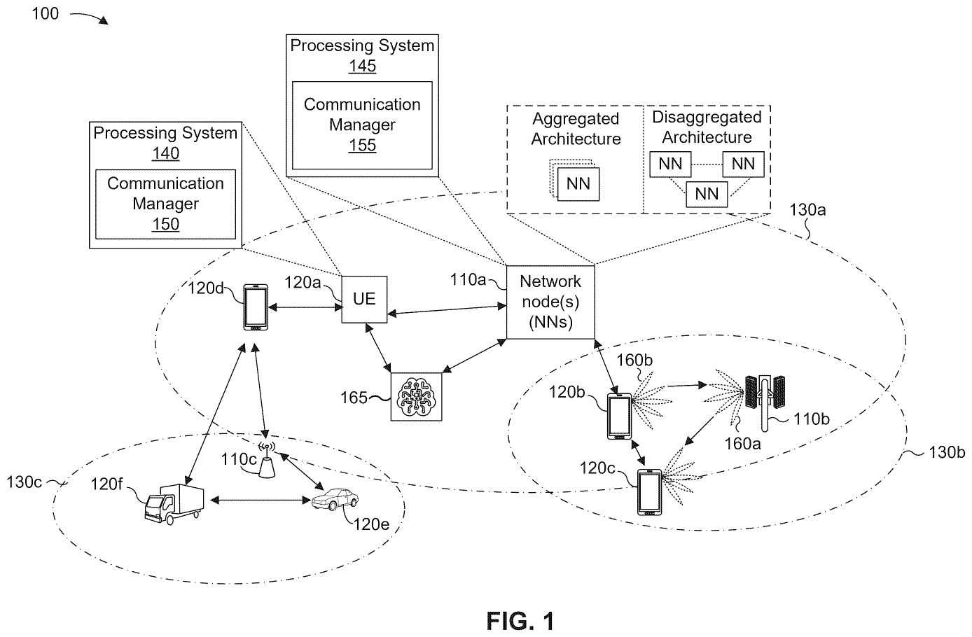

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 (e.g., the network nodes 110a, 110b, and 110c) support communication with a UE 120a, a UE 120b, a UE 120c, a UE 120d, a UE 120e, and a UE 120f. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

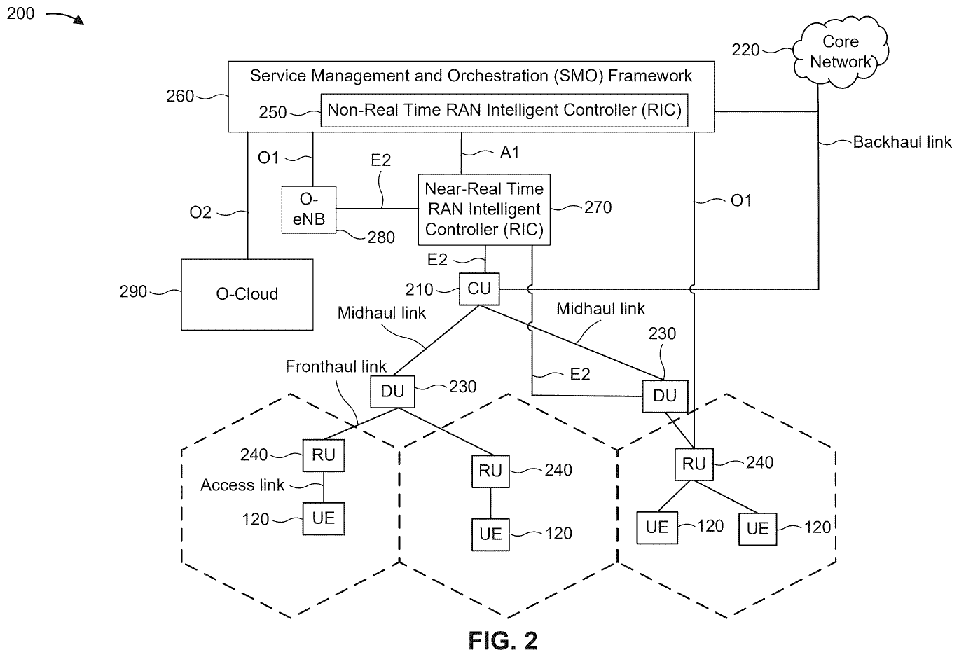

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some examples, two or more UEs 120 (for example, shown as UE 120a and UE 120d or the UE 120e and the UE 120f) may communicate directly with one another using sidelink communications (for example, without communicating by way of a network node 110 as an intermediary). As an example, the UE 120a may directly transmit data, control information, or other signaling as a sidelink communication to the UE 120EE. This is in contrast to, for example, the UE 120a first transmitting data in an uplink communication to a network node 110, which then transmits the data to the UE 120EE in a downlink communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. For example, the cell 130c may include a V2X network supported by the network node 110c. In some examples, the network node 110c may be a roadside unit or other device deployed in the V2X network. In some other deployments and configurations, a UE 120 (instead of a network node 110) may perform, or collaborate or negotiate with one or more other UEs to perform, scheduling operations, resource selection operations, and/or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

In some aspects, the UE 120 (e.g., a first UE or a paging UE) may include a communication manager 150. As described in more detail elsewhere herein, the communication manager 150 may receive, from a network node, a paging collaboration configuration that associates a first paging occasion with the first UE and a second paging occasion with a second UE; receive, in accordance with the paging collaboration configuration, a first paging request associated with the second UE during the first paging occasion; and transmit the first paging request to the second UE. Additionally, or alternatively, the communication manager 150 may perform one or more other operations described herein. For example, in some aspects, as described in more detail elsewhere herein, the communication manager 150 may receive, from a network node, a paging collaboration configuration that associates a first paging occasion with the paging UE and a second paging occasion with a relay UE; operate in a low-power mode on the first paging occasion; receive, from the relay UE and after the first paging occasion, a first paging request in accordance with the paging collaboration configuration; and transmit, to the network node, a response to the first paging request. Additionally, or alternatively, the communication manager 150 may perform one or more other operations described herein.

In some aspects, the network node 110 may include a communication manager 155. As described in more detail elsewhere herein, the communication manager 155 may output, to a first UE and to a second UE, a paging collaboration configuration; transmit, to the second UE, a first paging request associated with the first UE; and receive, from the first UE, a response to the first paging request. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

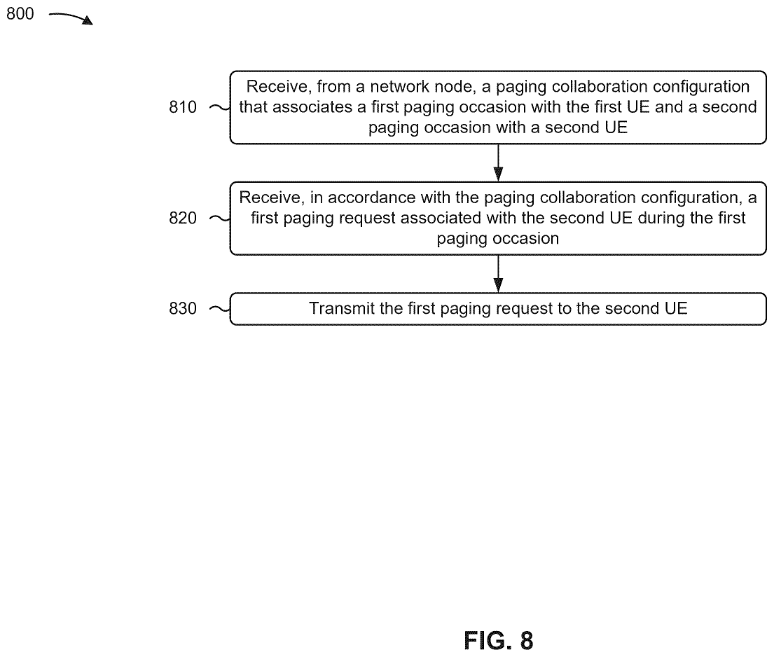

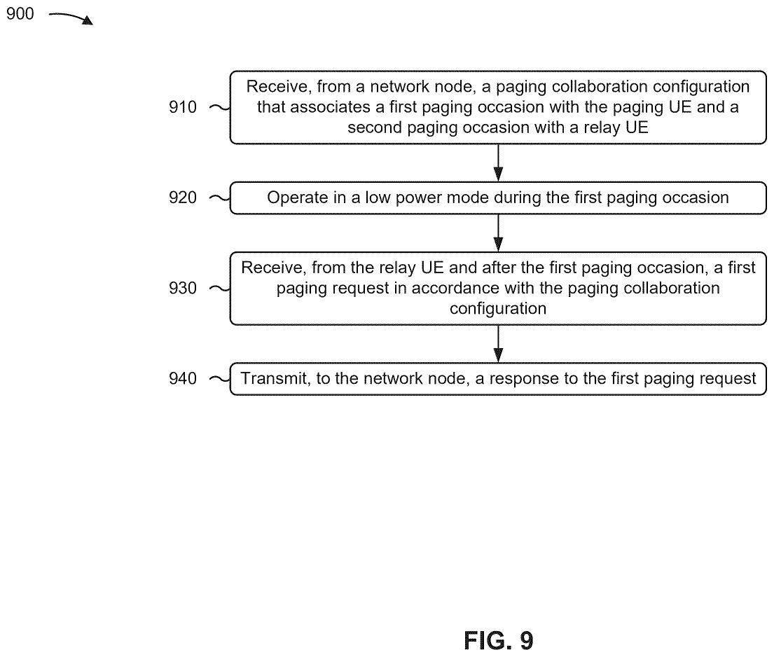

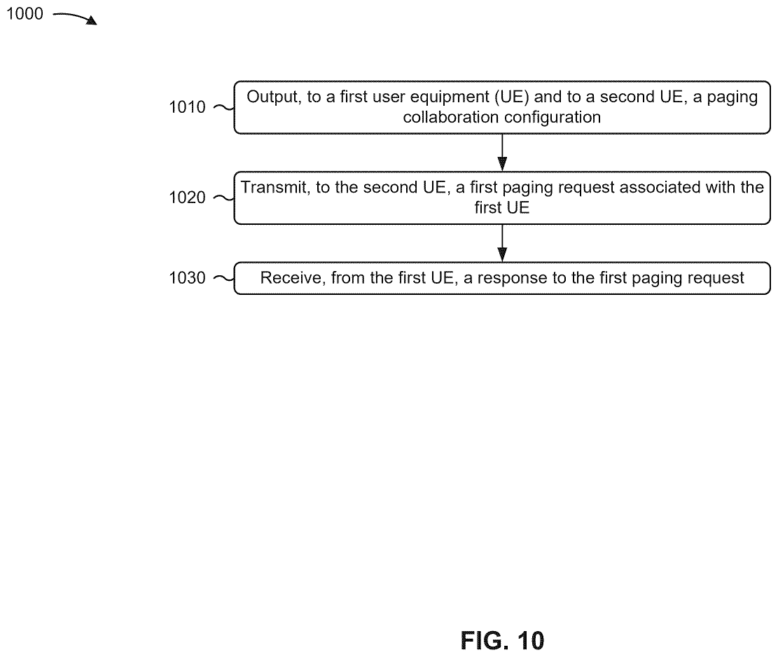

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with coordinating paging between multiple UEs, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, process 1000 of FIG. 10, or other processes as described herein. In some examples, executing instructions may include running the instructions, converting the instructions, compiling the instructions, and/or interpreting the instructions, among other examples.

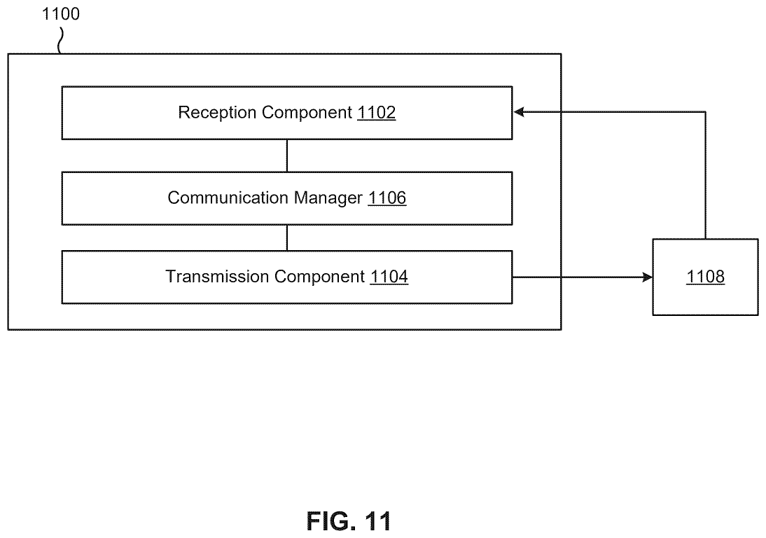

In some aspects, the UE 120 (e.g., the first UE) includes means for receiving, from a network node 110, a paging collaboration configuration that associates a first paging occasion with the first UE and a second paging occasion with a second UE; means for receiving, in accordance with the paging collaboration configuration, a first paging request associated with the second UE during the first paging occasion; and/or means for transmitting the first paging request to the second UE. In some aspects, the UE 120 (e.g., the paging UE) includes means for receiving, from a network node 110, a paging collaboration configuration that associates a first paging occasion with the paging UE and a second paging occasion with a relay UE; means for operating in a low-power mode on the first paging occasion; means for receiving, from the relay UE and after the first paging occasion, a first paging request in accordance with the paging collaboration configuration; and/or means for transmitting, to the network node, a response to the first paging request. The means for the paging UE to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11 and/or a transmission component (for example, transmission component 1104 depicted and described in connection with FIG. 11 among other examples.

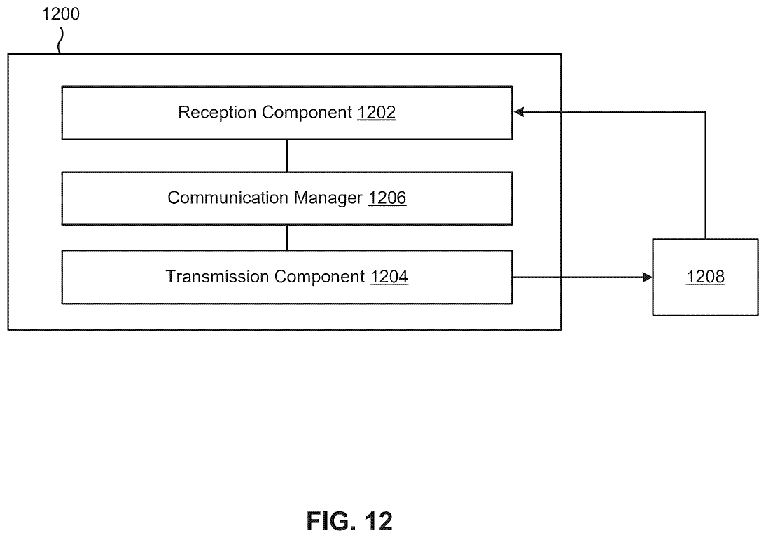

In some aspects, the network node 110 includes means for outputting, to a first UE and to a second UE, a paging collaboration configuration; means for transmitting, to the second UE, a first paging request associated with the first UE; and/or means for receiving, from the first UE, a response to the first paging request. The means for the network node 110 to perform operations described herein may include, for example, one or more of communication manager 155, processing system 150, a radio, one or more RF chains, one or more transceivers, one or more antennas, one or more modems, a reception component (for example, reception component 1202 depicted and described in connection with FIG. 12) and/or a transmission component (for example, transmission component 1204 depicted and described in connection with FIG. 12), among other examples.

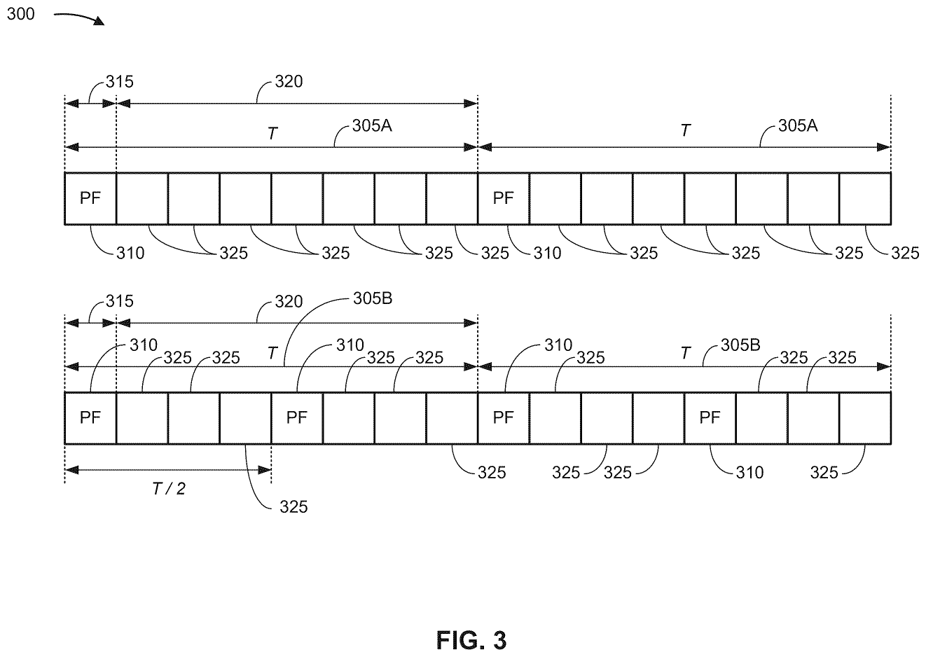

FIG. 3 is a diagram illustrating examples 300 of DRX cycles with UE paging frames (PFs), in accordance with the present disclosure. In FIG. 3, examples 300 include paging frames representing communication between a network node (e.g., a network node 110) and a UE (e.g., UE 120) in accordance with a DRX cycle. For example, as part of a DRX cycle (e.g., DRX cycle 305A or 305B), the UE may remain in a low-power state (e.g., an RRC idle mode or an RRC inactive mode) until a timer expires. When operating in the low-power state, a receiver (e.g., a main radio) of the UE may be turned off, and the UE may conserve power by remaining idle. The low-power state may persist until the timer reaches an on-duration 315. Upon expiration of the timer and entry into the on-duration 315, the UE may transition to an active state (e.g., an RRC connected state) where the UE monitors a downlink channel (e.g., the paging frames 310) for incoming data. The data received during the paging frames 310 may include a paging message or other relevant information. If the UE detects a paging message or other relevant data, the UE may process the information and respond accordingly, which may include operating in the active state for one or more non-paging frames 325. Once the on-duration expires and after the necessary communication has been processed, or if the UE does not receive a communication in the paging frame 310, the UE may transition to the low-power state (e.g., an off-duration 320). When operating in the low-power state, the UE may not monitor for any communications in non-paging frames 325. The DRX cycle 305A or 305B may be repeated so that the UE periodically operates in the low-power state and the active state.

As shown in FIG. 3, the DRX cycle 305A or 305B may include one or more paging frames 310 and one or more non-paging frames 325. For example, the example DRX cycle 305A may include one paging frame 310 per DRX cycle. Alternatively, the example DRX cycle 305B may include two paging frames 310 per DRX cycle. The number of paging frames N within the DRX cycle may depend on a defined division of time T within the DRX cycle, where Tis a length of time of the DRX cycle. The paging frames 310 may be spaced by a duration of T/N (e.g., T/2 as shown in FIG. 3). The duration and interval of the paging frames 310 within the DRX cycle may be fixed according to one or more paging configurations applied by the UE.

The position of paging frames 310 within the DRX cycle may be determined based, at least in part, on a unique identity of the UE. The locations of the paging frames 310, which may include one or more paging occasions, within the DRX cycle 305, may be a function of a UE identifier. Configurations for the paging frames 310 and/or paging occasions may be stored in the network to correspond with a specific UE. Each paging frame 310 may correspond to a specific point in time when the UE is scheduled to monitor a channel for paging messages, and each paging occasion may define an interval during which the UE may expect to receive paging messages. In some aspects, a paging occasion is a set of PDCCH monitoring occasions that includes multiple time slots (e.g., subframes or OFDM symbols) when DCI that includes a paging message can be transmitted to the UE. In accordance with the DRX cycle 305, and to save power, the UE may activate the receiver during the paging occasions and deactivate the receiver otherwise.

A paging frame 310 may be determined in accordance with a system frame number (SFN) defined as follows:

$$( S F N + P {F}_{offset} ) mod T = ( T div N ) * ( U {E}_{I D} mod N ) .$$

The SFN may represent a reference timing signal associated with the network, and the SEN may provide a unique identifier for each frame. In the context of paging, the SFN may be used in conjunction with other parameters to determine when a paging frame 310 is scheduled. The term PF_{offset} may be an offset value related to the paging frame 310 that may specify a time difference between the SFN and the scheduled paging frame, which may allow the network to identify a time at which the UE should monitor for paging messages. The term UE_{ID} (also called “UE ID”) may be a unique identifier for the UE that may be used by the network to associate a specific paging occasion and paging frame 310 to the UE. As discussed above, time T may represent a length of time of the DRX cycle, and N may represent the number of paging frames in the DRX cycle.

In some aspects, the paging frame 310 may be subdivided into one or more paging occasions, which as discussed above may refer to a specific instance within a paging frame 310 in which the UE is expected to monitor for paging messages. An index of the paging occasion may be defined as follows:

$${i}_{s} = floor ( \frac{U {E}_{I D}}{N} ) mod {N}_{s}$$

where is is the index, and Nₛ is the number of paging occasions within a paging frame 310.

As discussed above, a UE (e.g., a first UE) may be configured to operate as a UE-to-network relay (also referred to as a U2N relay) for sidelink communication with another UE (e.g., a second UE). In the context of a DRX cycle, the paging frames 310 may be instances during which the first UE (operating as a U2N relay) monitors a channel for paging messages from the network on behalf of the second UE. Each paging frame 310 may be associated with a specific period during which the first UE may activate a receiver to monitor the channel for any paging messages. The paging frames 310 may be separated by inactive intervals (e.g., the non-paging frames 325), during which the first UE may operate in a low-power mode (e.g., the off-duration 320). The positioning and occurrence of the paging frames 310 may be determined by a network configuration, including parameters such as the SFN and the UE ID.

In some aspects, to facilitate sidelink paging, the first UE may monitor the paging occasions of the second UE. The first UE may be configured to transmit paging information to the second UE through dedicated RRC signaling from the network node. The network node may transmit the dedicated RRC signaling to the first UE, which may transmit the paging information to the second UE. The dedicated RRC signaling for delivering remote UE paging may include a UE ID associated with the second UE. The UE ID may include a temporary mobile subscriber identity (TMSI) or an inactive radio network temporary identifier (I-RNTI). The first UE, when operating in the active state (e.g., an RRC connected state), may use UE ID to route paging messages to the second UE.

While the second UE may reduce power consumption when the first UE acts as a U2N relay for sidelink paging, the first UE cannot reduce power consumption because the first UE is expected to monitor the channel for paging messages intended for the second UE. Further, using the first UE as the U2N relay for sidelink paging does not improve latency because transmissions from the network node to the second UE occur only during paging occasions scheduled for the second UE. As discussed in greater detail below, both latency and power consumption can be improved by configuring the first UE to receive paging messages for the second UE on paging occasions scheduled for the first UE.

As indicated above, FIG. 3 is provided as an example. Other examples may differ from what is described with respect to FIG. 3.

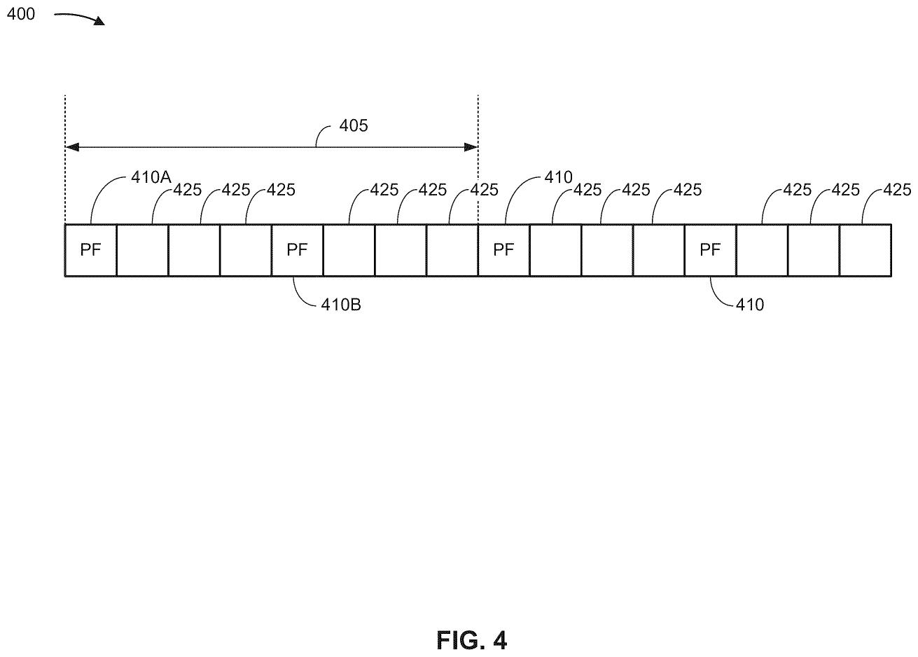

FIG. 4 is a diagram illustrating an example 400 associated with collaborative paging, in accordance with the present disclosure. In FIG. 4, example 400 includes, as part of a DRX cycle 405, paging frames 410 and non-paging frames 415 representing communications between a network node (e.g., network node 110), a relay UE (e.g., UE 120), and a paging UE (e.g., UE 120). In some aspects, a UE (e.g., a first UE) may periodically operate as the relay UE and periodically operate as the paging UE. Likewise, another UE (e.g., a second UE) may periodically operate as the paging UE and periodically operate as the relay UE. The first UE and the second UE may perform functions of the relay UE and/or the paging UE in accordance with a DRX cycle. For example, the first UE and the second UE may operate as the relay UE when in an active state (e.g., the on-duration 315 discussed above with respect to FIG. 3) of their respective DRX cycles and as a paging UE when in the inactive state (e.g., the off-duration 320 discussed above with respect to FIG. 3) of their respective DRX cycles.

In some examples, the relay UE and the paging UE may operate in accordance with a DRX cycle, such as the DRX cycle 405 shown in FIG. 4. In some aspects, the DRX cycle 405 may include multiple paging frames 410A and 410B. A first paging frame 410A may be associated with the paging UE and a second paging frame 410B may be associated with the relay UE. In some aspects, the relay UE may monitor a channel for paging messages intended for another UE (e.g., the paging UE). For example, in some aspects, the relay UE may monitor the channel for paging messages intended for the paging UE during the first paging frame 410A. In some aspects, the relay UE may transmit, to the paging UE, paging messages intended for the paging UE. Accordingly, in some aspects, if a paging request for the paging UE is missed by the paging UE in the first paging frame 410A in the DRX cycle 405, the network node may page the paging UE by transmitting the paging request to the relay UE in the second paging frame 410B in the DRX cycle 405. For example, during paging occasions associated with the relay UE, the relay UE may monitor the channel for paging requests intended for the paging UE and/or for the relay UE. Upon receiving the paging request for the paging UE, the relay UE may transmit the paging request to the relay UE.

In some aspects, the relay UE may transmit the paging request to the paging UE via a sidelink interface (e.g., a PC5 interface). In some aspects, the network node may transmit a system information block (SIB) or other system information (OSI) communication to indicate whether the relay UE and the paging UE can collaborate for sidelink paging within a particular cell. In accordance with the SIB or OSI, the relay UE may be configured to monitor, during paging occasions associated with the relay UE, for paging requests intended for the paging UE.

In some aspects, such as when the network node is aware of the collaboration between the paging UE and the relay UE, the network node (e.g., a core network or central unit) may include additional information in a paging request intended for the paging UE when the paging request is transmitted in a paging occasion for the relay UE. For example, in some aspects the additional information may include a UE ID associated with the paging UE, a list of paging frames 410 and/or paging occasions associated with the paging UE, a list of relay UEs (by UE ID) carried in a paging request, and/or a combination thereof, among other examples. In some aspects, the additional information may include a paging frame 410 and/or paging occasion that can be used to page the paging UE.

In some aspects, signaling between network nodes may be modified to facilitate paging as discussed herein. For example, in some aspects, a paging request between a core network and a gNB, or between a core network and a central unit, may be modified to include information about different paging frames 410 and/or paging occasions associated with the paging UE. In some aspects, signaling between a network node and a central unit may be updated to include information paging frames 410 and/or paging occasions for paging the paging UE. In some aspects, signaling between a central unit and a distributed unit may be updated to include information about paging frames 410 and/or paging occasions fore paging the paging UE.

In some aspects, the relay UE may be configured to receive, in the paging occasion for the relay UE, the paging request intended for the paging UE. In some aspects, the relay UE may be configured to indicate a capability or agreement to receive paging requests for the paging UE in paging occasions for the relay UE. In some aspects, the paging UE and/or the relay UE may be configured to share UE IDs, paging configurations, and/or a combination thereof, among other examples. In some aspects, the network node may be configured to page the paging UE in one or more paging occasions associated with the relay UE.

By collaborating (e.g., the relay UE monitoring for paging requests intended for the paging UE during the second paging occasion), the paging UE may receive the paging request without having to wait for a subsequent DRX cycle, which can increase latency. Further, by collaborating, the paging UE may spend more time in an inactive (e.g., low-power) state, thereby conserving more energy than if the paging UE were to operate in the active state more frequently and/or for longer periods of time.

As indicated above, FIG. 4 is provided as an example. Other examples may differ from what is described with respect to FIG. 4.

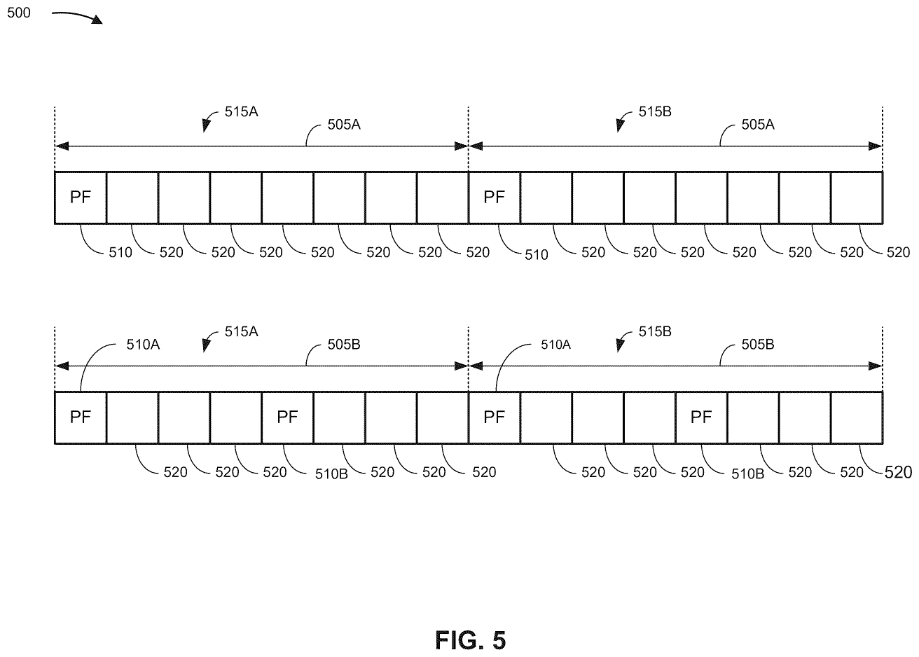

FIG. 5 is a diagram illustrating an example 500 associated with UE collaboration for sidelink paging, in accordance with the present disclosure. As shown in FIG. 5, example 500 includes paging frames 510 and non-paging frames 520 representing communication between a network node (e.g., network node 110), a relay UE (e.g., UE 120), and a paging UE (e.g., 120). In some aspects, a UE (e.g., a first UE) may periodically operate as the relay UE and periodically operate as the paging UE. Likewise, another UE (e.g., a second UE) may periodically operate as the paging UE and periodically operate as the relay UE. The first UE and the second UE may perform functions of the relay UE and/or the paging UE in accordance with a DRX cycle. For example, the first UE and the second UE may operate as the relay UE when in an active state of their respective DRX cycles and as a paging UE when in the inactive state of their respective DRX cycles.

As shown in the example 500 of FIG. 5, a first DRX cycle 505A may include one paging frame 510 and a second DRX cycle 505B may include two paging frames 510. In a first instance 515A of the first DRX cycle 505A, the first UE, operating as the relay UE, may monitor a channel in the paging frame 510 for paging requests intended for the second UE or for the first UE. For example, the first UE may monitor a channel in the paging frame for paging requests in a paging occasion associated with the first UE, in a paging occasion associated with the second UE, and/or a combination thereof, among other examples. The second UE may operate in a low-power mode during the first instance 515A of the first DRX cycle 505A. In a second instance 515B of the first DRX cycle 505A, the second UE, operating as the relay UE, may monitor a channel in the paging frame 510 for paging requests intended for the second UE or for the first UE. For example, the second UE may monitor a channel in the paging frame 510 for paging requests in a paging occasion associated with the first UE, in a paging occasion associated with the second UE, and/or a combination thereof, among other examples. The first UE may operate in a low-power mode during the second instances 515B of the first DRX cycle 505A.

In a first instance 515A of the second DRX cycle 505B, the first UE, operating as the relay UE, may monitor a channel in the first paging frame 510A and in the second paging frame 510B for paging requests intended for the second UE or for the first UE. For example, the first UE may monitor a channel in the first paging frame 510A for paging requests in a paging occasion associated with the first UE, in a paging occasion associated with the second UE, and/or a combination thereof, among other examples. The second UE may operate in a low-power mode during the first instance 515A of the second DRX cycle 505B. In a second instances 515B of the second DRX cycle 505B, the second UE, operating as the relay UE, may monitor a channel in the first paging frame 510A for paging requests intended for the second UE or for the first UE, and monitor a channel in the second paging frame 510B for paging requests intended for the second UE or the first UE. For example, the second UE may monitor the channel in the first paging frame 510A and in the second paging frame 510B for paging requests in a paging occasion associated with the first UE, in a paging occasion associated with the second UE, and/or a combination thereof, among other examples. The first UE may operate in a low-power mode during the second instances 515B of the second DRX cycle 505B.

In some aspects, the network node may assign a common group identifier (e.g., a common paging occasion) for the first UE and the second UE. In some aspects, the common group identifier may also be associated with other UEs. In some aspects, the first UE and the second UE may collaborate with one another such that, within a DRX cycle, such as the first DRX cycle 505A and/or the second DRX cycle 505B, one of the first UE or the second UE may monitor the common paging occasion for the paging request for any UE associated with the common group identifier. In some aspects, the network node may transmit a SIB or OSI to the UEs (e.g., the first UE and the second UE) associated with the common group identifier to indicate that the cell supports this feature.

While operations of two UEs (e.g., the first UE and the second UE) are discussed in the example 500 of FIG. 5, latency and power consumption may be improved by having more UEs monitor the channel for paging requests during DRX cycles. For example, each UE may operate in an inactive (e.g., low-power) mode for a longer period of time than if the UE is required to monitor the channel for its own paging requests. Additionally, latency may be improved because, as the number of UEs increases, the network has more opportunities to transmit a paging request for a particular UE.

As indicated above, FIG. 5 is provided as an example. Other examples may differ from what is described with respect to FIG. 5.

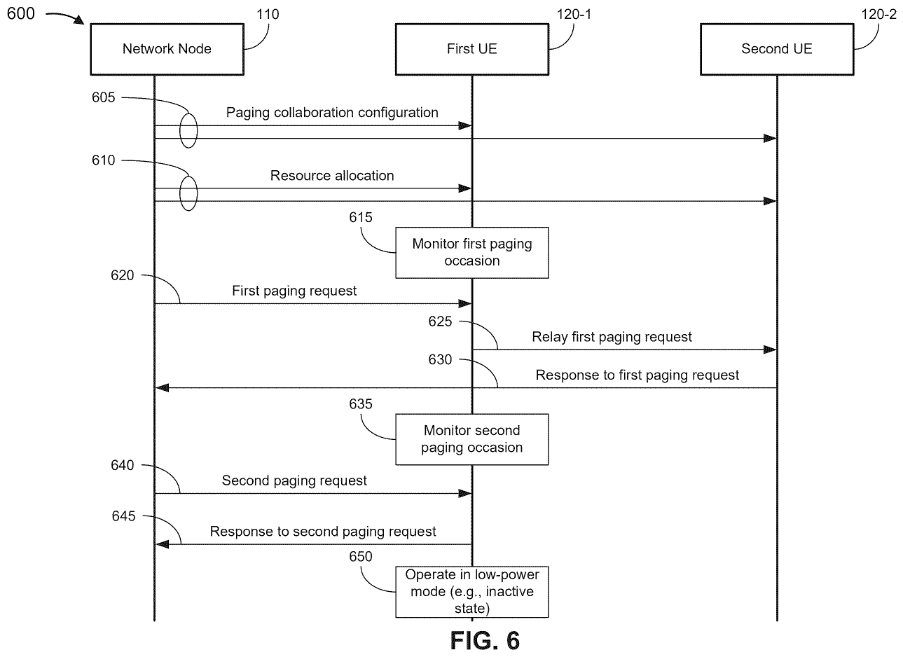

FIG. 6 is a diagram illustrating an example 600 associated with paging collaboration, in accordance with the present disclosure. As shown in FIG. 6, a network node 110, a first UE 120-1, and a second UE 120-2 may communicate with one another.

As shown by reference number 605, the first UE 120-1 and the second UE 120-2 may receive, and the network node 110 may transmit, a paging collaboration configuration. In some aspects, the paging collaboration configuration may associate a first paging occasion with the first UE 120-1 and a second paging occasion with a second UE 120-2. In some aspects, the network node 110 may transmit SIB and/or OSI associated with capabilities of one or more cells serving the first UE 120-1 and/or the second UE 120-2. In some aspects, the SIB and/or OSI may indicate, to the first UE 120-1 and the second UE 120-2 capabilities of the one or more cells for one or more features associated with the paging collaboration configuration. In some aspects, the first UE 120-1 and/or the second UE 120-2 may transmit a capability indication associated with support, by the first UE 120-1 and/or the second UE 120-2, respectively, for the paging collaboration configuration.

As shown by reference number 610, the first UE 120-1 may receive, and the network node 110 may transmit, a resource allocation for a first paging occasion and a second paging occasion. The resource allocation may, in some aspects, configure one or more resources for the first UE 120-1 to transmit a paging request to the second UE 120-2, for the first UE 120-1 and/or the second UE 120-2 to transmit a response to a paging request, and/or a combination thereof, among other examples.

As shown by reference number 615, the first UE 120-1 may monitor the first paging occasion. For example, the first UE 120-1 may monitor a channel for a paging request during the first paging occasion.

As shown by reference number 620, the first UE 120-1 may receive, and the network node 110 may transmit, the first paging request in the first paging occasion. In some aspects, the first paging request may be associated with the second UE 120-2.

As shown by reference number 625, the first UE 120-1 may transmit, and the second UE 120-2 may receive, the first paging request. In some aspects, the first UE 120-1 may transmit the first paging request to the second UE 120-2 via a sidelink communication, such as a communication over a PC5 interface.

As shown by reference number 630, the second UE 120-2 may transmit, and the network node 110 may receive, a response to the first paging request.

As shown by reference number 635, the first UE 120-1 may monitor a second paging occasion. For example, the first UE 120-1 may monitor a channel for a paging request during the second paging occasion. In some aspects, the second paging occasion may be during a same or different DRX cycle as the first paging occasion.

As shown by reference number 640, the first UE 120-1 may receive a second paging request. In some aspects, the second paging request may be received, by the first UE 120-1 from the network node. For example, the first UE 120-1 may receive the second paging request during the second paging occasion if the second paging occasion is associated with the first UE 120-1. Alternatively, in some aspects, the first UE 120-1 may receive the second paging request from the second UE 120-2 in accordance with the paging collaboration configuration. For example, the first UE 120-1 may receive the second paging request from the second UE 120-2 if the second paging occasion is associated with the second UE 120-2.

As shown by reference number 645, the first UE 120-1 may transmit, and the network node 110 may receive, a response to the second paging request. In some aspects, the first UE 120-1 may transmit the response to the second paging request as a result of the first UE 120-1 receiving the second paging request from the network node 110 or from the second UE 120-2.

In some aspects, the first paging request includes an identifier associated with the second UE 120-2. In some aspects, the first paging request includes an identifier associated with one or more paging frames. In some aspects, the first paging request includes an identifier associated with one or more paging occasions. In some aspects, the first paging request includes an identifier associated with one or more assisting UEs (e.g., including the first UE 120-1). In some aspects, the second paging request includes an identifier associated with the first UE 120-1. In some aspects, the second paging request includes an identifier associated with one or more paging frames. In some aspects, the second paging request includes an identifier associated with one or more paging occasions. In some aspects, the second paging request includes an identifier associated with one or more assisting UEs (e.g., including the second UE 120-1).

As shown by reference number 650, the first UE 120-1 may transition to a low-power mode (e.g., the inactive state) for a duration of the DRX cycle. In some aspects, the first UE 120-1 may transition to the low-power mode after transmitting the response to the second paging request. In some aspects, such as if no paging requests are transmitted during the second paging occasion, the first UE 120-1 may transition to the low-power mode after the second paging occasion. In some aspects, such as if the second UE 120-2 is configured to monitor for paging requests on behalf of the first UE 120-1 during a subsequent DRX cycle, the first UE 120-1 may remain in the low-power mode for a duration of the subsequent DRX cycle.

As indicated above, FIG. 6 is provided as an example. Other examples may differ from what is described with respect to FIG. 6.

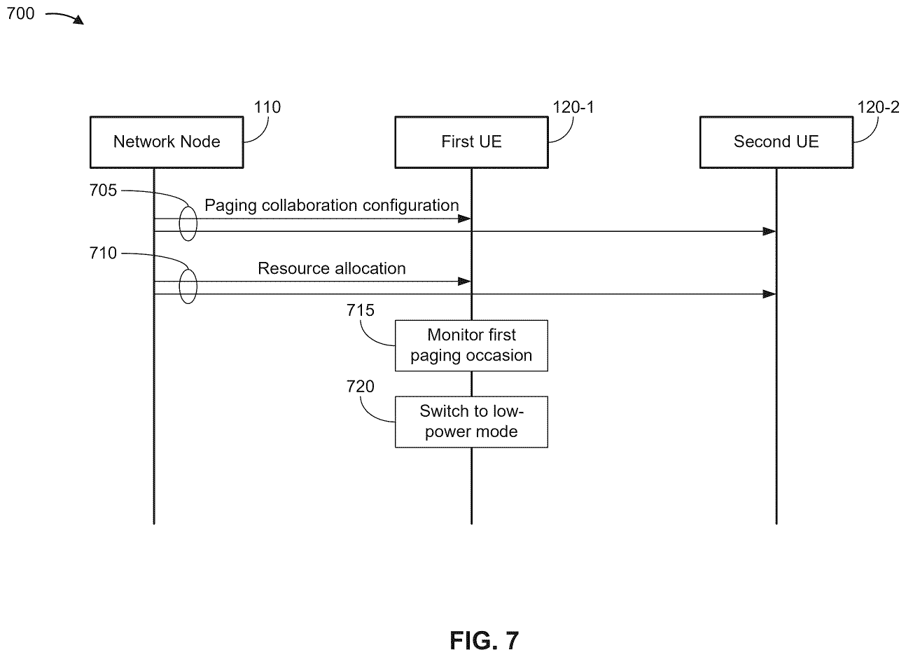

FIG. 7 is a diagram illustrating an example 700 associated with paging collaboration for DRX, in accordance with the present disclosure. As shown in FIG. 7, a network node 110, a first UE 120-1, and a second UE 120-2 may communicate with one another.

As shown by reference number 705, the first UE 120-1 and the second UE 120-2 may receive, and the network node 110 may transmit, a paging collaboration configuration. In some aspects, the paging collaboration configuration may associate a first paging occasion with the first UE 120-1 and a second paging occasion with a second UE 120-2. In some aspects, the network node 110 may transmit SIB and/or OSI associated with capabilities of one or more cells serving the first UE 120-1 and/or the second UE 120-2. In some aspects, the SIB and/or OSI may indicate, to the first UE 120-1 and the second UE 120-2 capabilities of the one or more cells for one or more features associated with the paging collaboration configuration. In some aspects, the first UE 120-1 and/or the second UE 120-2 may transmit a capability indication associated with support, by the first UE 120-1 and/or the second UE 120-2, respectively, for the paging collaboration configuration.

As shown by reference number 710, the first UE 120-1 may receive, and the network node 110 may transmit, a resource allocation for a first paging occasion and a second paging occasion. The resource allocation may, in some aspects, configure one or more resources for the first UE 120-1 to transmit a paging request to the second UE 120-2, for the first UE 120-1 and/or the second UE 120-2 to transmit a response to a paging request, and/or a combination thereof, among other examples.

As shown by reference number 715, the first UE 120-1 may monitor, in accordance with the paging collaboration configuration, the first paging occasion during a first DRX cycle. In some aspects, the first DRX cycle is a first instance of a DRX cycle. For example, the first UE 120-1 may monitor a channel for the first paging request during a first paging frame of the first DRX cycle.

As shown by reference number 720, the first UE 120-1 may operate, in accordance with the paging collaboration configuration, in a low-power mode after monitoring for the paging request during the first paging occasion. For example, in some aspects, the first UE 120-1 may operate in the low-power mode for a portion of the first DRX cycle after the first paging occasion. In some aspects, the first UE 120-1 may continue to operate in the low-power mode for a remainder of the first DRX cycle, after the first paging occasion or after a second paging occasion in the first DRX cycle. In some aspects, the first UE 120-1 may operate in the low-power mode during a third paging occasion in a second DRX cycle (e.g., a second instance of the DRX cycle). In some aspects, the second paging occasion may be associated with the second UE 120-2, and the third paging occasion may be associated with the first UE 120-1. In some aspects, operating in the low-power mode for the portion of the first DRX cycle may include operating in the low-power mode for a number (e.g., quantity) of DRX cycles in accordance with the paging collaboration configuration.

In some aspects, the paging collaboration configuration includes a common group identifier that identifies at least the first UE 120-1 and the second UE 120-2. In some aspects, the first UE 120-1 and the second UE 120-2 may be configured to monitor one or more paging occasions (e.g., the first paging occasion, the second paging occasion, the third paging occasion, among other examples) in accordance with the common group identifier. For example, as discussed above, the first UE 120-1 and/or the second UE 120-2 may be configured to monitor one or more paging occasions for paging requests intended for any UE identified by the common group identifier.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., the first UE 120-1) performs operations associated with UE paging collaboration.

As shown in FIG. 8, in some aspects, process 800 may include receiving, from a network node, a paging collaboration configuration that associates a first paging occasion with the first UE and a second paging occasion with a second UE (block 810). For example, the UE (e.g., using reception component 1102 and/or communication manager 1106, depicted in FIG. 11) may receive, from a network node, a paging collaboration configuration that associates a first paging occasion with the first UE and a second paging occasion with a second UE, as described above.

As further shown in FIG. 8, in some aspects, process 800 may include receiving, in accordance with the paging collaboration configuration, a first paging request associated with the second UE during the first paging occasion (block 820). For example, the UE (e.g., using reception component 1102 and/or communication manager 1106, depicted in FIG. 11) may receive, in accordance with the paging collaboration configuration, a first paging request associated with the second UE during the first paging occasion, as described above.

As further shown in FIG. 8, in some aspects, process 800 may include transmitting the first paging request to the second UE (block 830). For example, the UE (e.g., using transmission component 1104 and/or communication manager 1106, depicted in FIG. 11) may transmit the first paging request to the second UE, as described above.

Process 800 may include additional aspects, such as any single aspect or any combination of aspects described below and/or in connection with one or more other processes described elsewhere herein.

In a first aspect, the first paging request is transmitted to the second UE via a sidelink communication.

In a second aspect, alone or in combination with the first aspect, process 800 includes receiving a resource allocation for the first paging occasion and the second paging occasion, receiving, from the network node, a second paging request during the second paging occasion, and transmitting, to the network node, a response to the second paging request.

In a third aspect, alone or in combination with one or more of the first and second aspects, process 800 includes monitoring for the first paging request during a first paging occasion, receiving, from the second UE, a second paging request in accordance with the paging collaboration configuration, and transmitting, to the network node, a response to the second paging request.

In a fourth aspect, alone or in combination with one or more of the first through third aspects, the first paging request includes one or more of an identifier associated with the second UE, an identifier associated with one or more paging frames, an identifier associated with one or more paging occasions, or an identifier associated with one or more assisting UEs.

In a fifth aspect, alone or in combination with one or more of the first through fourth aspects, process 800 includes monitoring, in accordance with the paging collaboration configuration, the first paging occasion during a first DRX cycle, monitoring, in accordance with the paging collaboration configuration, the second paging occasion during the first DRX cycle, and operating in a low-power mode for a portion of the first DRX cycle and on a third paging occasion of a second DRX cycle in accordance with the paging collaboration configuration, wherein the third paging occasion is associated with the first UE.

In a sixth aspect, alone or in combination with one or more of the first through fifth aspects, operating in the low-power mode for the portion of the first DRX cycle includes operating in the low-power mode for a remaining duration of the first DRX cycle after the second paging occasion and for an entirety of the second DRX cycle.

In a seventh aspect, alone or in combination with one or more of the first through sixth aspects, the paging collaboration configuration includes a common group identifier.

In an eighth aspect, alone or in combination with one or more of the first through seventh aspects, the first paging occasion and the second paging occasion are monitored in accordance with the common group identifier.

In a ninth aspect, alone or in combination with one or more of the first through eighth aspects, process 800 includes operating in a low-power mode for a number of DRX cycles in accordance with the paging collaboration configuration.

In a tenth aspect, alone or in combination with one or more of the first through ninth aspects, process 800 includes transmitting, to the network node, a capability indication associated with the paging collaboration configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a paging UE or an apparatus of a paging UE, in accordance with the present disclosure. Example process 900 is an example where the apparatus or the UE (e.g., a UE 120) performs operations associated with UE paging collaboration.

As shown in FIG. 9, in some aspects, process 900 may include receiving, from a network node, a paging collaboration configuration that associates a first paging occasion with the paging UE and a second paging occasion with a relay UE (block 910). For example, the paging UE (e.g., using reception component 1102 and/or communication manager 1106, depicted in FIG. 11) may receive, from a network node, a paging collaboration configuration that associates a first paging occasion with the paging UE and a second paging occasion with a relay UE, as described above.

As further shown in FIG. 9, in some aspects, process 900 may include operating in a low-power mode on the first paging occasion (block 920). For example, the paging UE (e.g., using communication manager 1106, depicted in FIG. 11) may operate in a low-power mode on the first paging occasion, as described above.

As further shown in FIG. 9, in some aspects, process 900 may include receiving, from the relay UE and after the first paging occasion, a first paging request in accordance with the paging collaboration configuration (block 930). For example, the paging UE (e.g., using reception component 1102 and/or communication manager 1106, depicted in FIG. 11) may receive, from the relay UE and after the first paging occasion, a first paging request in accordance with the paging collaboration configuration, as described above.

As further shown in FIG. 9, in some aspects, process 900 may include transmitting, to the network node, a response to the first paging request (block 940). For example, the paging UE (e.g., using transmission component 1104 and/or communication manager 1106, depicted in FIG. 11) may transmit, to the network node, a response to the first paging request, as described above.

Process 900 may include additional aspects, such as any single aspect or any combination of aspects described below and/or in connection with one or more other processes described elsewhere herein.

In a first aspect, the first paging request is received from the relay UE via a sidelink communication.

In a second aspect, alone or in combination with the first aspect, process 900 includes transmitting, to the network node, a capability indication associated with the paging collaboration configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with UE paging collaboration.

As shown in FIG. 10, in some aspects, process 1000 may include outputting, to a first UE and to a second UE, a paging collaboration configuration (block 1010). For example, the network node (e.g., using transmission component 1204 and/or communication manager 1206, depicted in FIG. 12) may output, to a first UE and to a second UE, a paging collaboration configuration, as described above.

As further shown in FIG. 10, in some aspects, process 1000 may include transmitting, to the second UE, a first paging request associated with the first UE (block 1020). For example, the network node (e.g., using transmission component 1204 and/or communication manager 1206, depicted in FIG. 12) may transmit, to the second UE, a first paging request associated with the first UE, as described above.

As further shown in FIG. 10, in some aspects, process 1000 may include receiving, from the first UE, a response to the first paging request (block 1030). For example, the network node (e.g., using reception component 1202 and/or communication manager 1206, depicted in FIG. 12) may receive, from the first UE, a response to the first paging request, as described above.

Process 1000 may include additional aspects, such as any single aspect or any combination of aspects described below and/or in connection with one or more other processes described elsewhere herein.

In a first aspect, process 1000 includes outputting, to the first UE and to the second UE, a resource allocation for a first paging occasion and a second paging occasion, wherein the paging collaboration configuration associates the first paging occasion with the first UE and the second paging occasion with the second UE, and wherein the first paging request is transmitted to the second UE during the first paging occasion, and transmitting a second paging request to the first UE on the second paging occasion.

In a second aspect, alone or in combination with the first aspect, the first paging request is transmitted to the second UE on a first paging occasion associated with the first UE as a result of a failed acknowledge of the first paging request.

In a third aspect, alone or in combination with one or more of the first and second aspects, process 1000 includes receiving, from the second UE, a response to the second paging request.

In a fourth aspect, alone or in combination with one or more of the first through third aspects, the first paging request includes one or more of an identifier associated with one or more of the first UE or the second UE, an identifier associated with one or more paging frames, an identifier associated with one or more paging occasions, or an identifier associated with one or more assisting UEs.

In a fifth aspect, alone or in combination with one or more of the first through fourth aspects, the first UE an the second UE are assigned a common group identifier.

In a sixth aspect, alone or in combination with one or more of the first through fifth aspects, process 1000 includes receiving a first capability indication from the first UE, wherein the first capability indication indicates support by the first UE for the paging collaboration configuration, and receiving a second capability indication from the second UE, wherein the second capability indication indicates support by the second UE for the paging collaboration configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 4-7. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

In some aspects, the reception component 1102 may receive, from a network node, a paging collaboration configuration that associates a first paging occasion with the first UE and a second paging occasion with a second UE. The reception component 1102 may receive, in accordance with the paging collaboration configuration, a first paging request associated with the second UE during the first paging occasion. The transmission component 1104 may transmit the first paging request to the second UE. The reception component 1102 may receive a resource allocation for the first paging occasion and the second paging occasion. The reception component 1102 may receive, from the network node, a second paging request during the second paging occasion. The transmission component 1104 may transmit, to the network node, a response to the second paging request. The communication manager 1106 may monitor for the first paging request during a first paging occasion receiving, from the second UE, a second paging request in accordance with the paging collaboration configuration; and transmitting, to the network node, a response to the second paging request. The communication manager 1106 may monitor, in accordance with the paging collaboration configuration, the first paging occasion during a first DRX cycle. The communication manager 1106 may monitor, in accordance with the paging collaboration configuration, the second paging occasion during the first DRX cycle. The communication manager 1106 may operate in a low-power mode for a portion of the first DRX cycle and on a third paging occasion of a second DRX cycle in accordance with the paging collaboration configuration wherein the third paging occasion is associated with the first UE. The communication manager 1106 may operate in a low-power mode for a number of DRX cycles in accordance with the paging collaboration configuration. The transmission component 1104 may transmit, to the network node, a capability indication associated with the paging collaboration configuration.

In some aspects, the reception component 1102 may receive, from a network node, a paging collaboration configuration that associates a first paging occasion with the paging UE and a second paging occasion with a relay UE. The communication manager 1106 may operate in a low-power mode on the first paging occasion. The reception component 1102 may receive, from the relay UE and after the first paging occasion, a first paging request in accordance with the paging collaboration configuration. The transmission component 1104 may transmit, to the network node, a response to the first paging request. The transmission component 1104 may transmit, to the network node, a capability indication associated with the paging collaboration configuration.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 4-7. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may output, to a first UE and to a second UE, a paging collaboration configuration. The transmission component 1204 may transmit, to the second UE, a first paging request associated with the first UE. The reception component 1202 may receive, from the first UE, a response to the first paging request. The transmission component 1204 may output, to the first UE and to the second UE, a resource allocation for a first paging occasion and a second paging occasion, wherein the paging collaboration configuration associates the first paging occasion with the first UE and the second paging occasion with the second UE, and wherein the first paging request is transmitted to the second UE during the first paging occasion. The transmission component 1204 may transmit a second paging request to the first UE on the second paging occasion. The reception component 1202 may receive, from the second UE, a response to the second paging request. The reception component 1202 may receive a first capability indication from the first UE, wherein the first capability indication indicates support by the first UE for the paging collaboration configuration. The reception component 1202 may receive a second capability indication from the second UE, wherein the second capability indication indicates support by the second UE for the paging collaboration configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first UE, comprising: receiving, from a network node, a paging collaboration configuration that associates a first paging occasion with the first UE and a second paging occasion with a second UE; receiving, in accordance with the paging collaboration configuration, a first paging request associated with the second UE during the first paging occasion; and transmitting the first paging request to the second UE.

Aspect 2: The method of Aspect 1, wherein the first paging request is transmitted to the second UE via a sidelink communication.

Aspect 3: The method of any of Aspects 1-2, further comprising: receiving a resource allocation for the first paging occasion and the second paging occasion; receiving, from the network node, a second paging request during the second paging occasion; and transmitting, to the network node, a response to the second paging request.

Aspect 4: The method of any of Aspects 1-3, further comprising: monitoring for the first paging request during a first paging occasion; receiving, from the second UE, a second paging request in accordance with the paging collaboration configuration; and transmitting, to the network node, a response to the second paging request.

Aspect 5: The method of any of Aspects 1-4, wherein the first paging request includes one or more of an identifier associated with the second UE, an identifier associated with one or more paging frames, an identifier associated with one or more paging occasions, or an identifier associated with one or more assisting UEs.

Aspect 6: The method of any of Aspects 1-5, further comprising: monitoring, in accordance with the paging collaboration configuration, the first paging occasion during a first DRX cycle; monitoring, in accordance with the paging collaboration configuration, the second paging occasion during the first DRX cycle; and operating in a low-power mode for a portion of the first DRX cycle and on a third paging occasion of a second DRX cycle in accordance with the paging collaboration configuration, wherein the third paging occasion is associated with the first UE.

Aspect 7: The method of Aspect 6, wherein operating in the low-power mode for the portion of the first DRX cycle includes operating in the low-power mode for a remaining duration of the first DRX cycle after the second paging occasion and for an entirety of the second DRX cycle.

Aspect 8: The method of Aspect 6, wherein the paging collaboration configuration includes a common group identifier.

Aspect 9: The method of Aspect 8, wherein the first paging occasion and the second paging occasion are monitored in accordance with the common group identifier.

Aspect 10: The method of any of Aspects 1-9, further comprising operating in a low-power mode for a number of DRX cycles in accordance with the paging collaboration configuration.

Aspect 11: The method of any of Aspects 1-10, further comprising transmitting, to the network node, a capability indication associated with the paging collaboration configuration.

Aspect 12: A method of wireless communication performed by a paging UE, comprising: receiving, from a network node, a paging collaboration configuration that associates a first paging occasion with the paging UE and a second paging occasion with a relay UE; operating in a low-power mode on the first paging occasion; receiving, from the relay UE and after the first paging occasion, a first paging request in accordance with the paging collaboration configuration; and transmitting, to the network node, a response to the first paging request.

Aspect 13: The method of Aspect 12, wherein the first paging request is received from the relay UE via a sidelink communication.

Aspect 14: The method of any of Aspects 12-13, further comprising transmitting, to the network node, a capability indication associated with the paging collaboration configuration.

Aspect 15: A method of wireless communication performed by a network node, comprising: outputting, to a first UE and to a second UE, a paging collaboration configuration; transmitting, to the second UE, a first paging request associated with the first UE; and receiving, from the first UE, a response to the first paging request.

Aspect 16: The method of Aspect 15, further comprising: outputting, to the first UE and to the second UE, a resource allocation for a first paging occasion and a second paging occasion, wherein the paging collaboration configuration associates the first paging occasion with the first UE and the second paging occasion with the second UE, and wherein the first paging request is transmitted to the second UE during the first paging occasion; and transmitting a second paging request to the first UE on the second paging occasion.

Aspect 17: The method of any of Aspects 15-16, wherein the first paging request is transmitted to the second UE on a first paging occasion associated with the first UE as a result of a failed acknowledge of the first paging request.

Aspect 18: The method of Aspect 16, further comprising receiving, from the second UE, a response to the second paging request.

Aspect 19: The method of any of Aspects 15-18, wherein the first paging request includes one or more of an identifier associated with one or more of the first UE or the second UE, an identifier associated with one or more paging frames, an identifier associated with one or more paging occasions, or an identifier associated with one or more assisting UEs.

Aspect 20: The method of any of Aspects 15-19, wherein the first UE an the second UE are assigned a common group identifier.

Aspect 21: The method of any of Aspects 15-20, further comprising: receiving a first capability indication from the first UE, wherein the first capability indication indicates support by the first UE for the paging collaboration configuration; and receiving a second capability indication from the second UE, wherein the second capability indication indicates support by the second UE for the paging collaboration configuration.

Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.

Aspect 23: An apparatus for wireless communication at a device, the apparatus comprising one or more memories and one or more processors coupled to the one or more memories, the one or more processors configured to cause the device to perform the method of one or more of Aspects 1-21.

Aspect 24: An apparatus for wireless communication, the apparatus comprising at least one means for performing the method of one or more of Aspects 1-21.

Aspect 25: A non-transitory computer-readable medium storing code for wireless communication, the code comprising instructions executable by one or more processors to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

Aspect 27: A device for wireless communication, the device comprising a processing system that includes one or more processors and one or more memories coupled with the one or more processors, the processing system configured to cause the device to perform the method of one or more of Aspects 1-21.

Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first user equipment (UE) for wireless communication, comprising:
one or more memories; and
one or more processors, coupled to the one or more memories, configured to cause the UE to:
receive, from a network node, a paging collaboration configuration that associates a first paging occasion with the first UE and a second paging occasion with a second UE;
receive, in accordance with the paging collaboration configuration, a first paging request associated with the second UE during the first paging occasion; and
transmit the first paging request to the second UE.

2. The first UE of claim 1, wherein the first paging request is transmitted to the second UE via a sidelink communication.

3. The first UE of claim 1, wherein the one or more processors are further configured to cause the first UE to:
receive a resource allocation for the first paging occasion and the second paging occasion;
receive, from the network node, a second paging request during the second paging occasion; and
transmit, to the network node, a response to the second paging request.

4. The first UE of claim 1, wherein the one or more processors are further configured to cause the first UE to:
monitor for the first paging request during the first paging occasion;
receive, from the second UE, a second paging request in accordance with the paging collaboration configuration; and
transmit, to the network node, a response to the second paging request.

5. The first UE of claim 1, wherein the first paging request includes one or more of an identifier associated with the second UE, an identifier associated with one or more paging frames, an identifier associated with one or more paging occasions, or an identifier associated with one or more assisting UEs.

6. The first UE of claim 1, wherein the one or more processors are further configured to cause the first UE to:
monitor, in accordance with the paging collaboration configuration, the first paging occasion during a first discontinuous reception (DRX) cycle;
monitor, in accordance with the paging collaboration configuration, the second paging occasion during the first DRX cycle; and
operate in a low power mode for a portion of the first DRX cycle and during a third paging occasion of a second DRX cycle in accordance with the paging collaboration configuration, wherein the third paging occasion is associated with the first UE.

7. The first UE of claim 6, wherein the one or more processors, to cause the first UE to operate in the low power mode for the portion of the first DRX cycle, are configured to cause the first UE to operate in the low power mode for a remaining duration of the first DRX cycle after the second paging occasion and for an entirety of the second DRX cycle.

8. The first UE of claim 6, wherein the paging collaboration configuration includes a common group identifier.

9. The first UE of claim 8, wherein the first paging occasion and the second paging occasion are monitored in accordance with the common group identifier.

10. The first UE of claim 1, wherein the one or more processors are further configured to cause the first UE to operate in a low power mode for a number of discontinuous reception (DRX) cycles in accordance with the paging collaboration configuration.

11. The first UE of claim 1, wherein the one or more processors are further configured to cause the first UE to transmit, to the network node, a capability indication associated with the paging collaboration configuration.

12. A paging user equipment (UE) for wireless communication, comprising:
one or more memories; and
one or more processors, coupled to the one or more memories, configured to cause the paging UE to:
receive, from a network node, a paging collaboration configuration that associates a first paging occasion with the paging UE and a second paging occasion with a relay UE;
operate in a low power mode during the first paging occasion;
receive, from the relay UE and after the first paging occasion, a first paging request in accordance with the paging collaboration configuration; and
transmit, to the network node, a response to the first paging request.

13. The UE of claim 12, wherein the first paging request is received from the relay UE via a sidelink communication.

14. A method of wireless communication performed by a first user equipment (UE), comprising:
receiving, from a network node, a paging collaboration configuration that associates a first paging occasion with the first UE and a second paging occasion with a second UE;
receiving, in accordance with the paging collaboration configuration, a first paging request associated with the second UE during the first paging occasion; and
transmitting the first paging request to the second UE.

15. The method of claim 14, further comprising:
monitoring for the first paging request during the first paging occasion;
receiving, from the second UE, a second paging request in accordance with the paging collaboration configuration; and
transmitting, to the network node, a response to the second paging request.

16. The method of claim 14, wherein the first paging request includes one or more of an identifier associated with the second UE, an identifier associated with one or more paging frames, an identifier associated with one or more paging occasions, or an identifier associated with one or more assisting UEs.

17. The method of claim 14, further comprising:
monitoring, in accordance with the paging collaboration configuration, the first paging occasion during a first discontinuous reception (DRX) cycle;
monitoring, in accordance with the paging collaboration configuration, the second paging occasion during the first DRX cycle; and
operating in a low power mode for a portion of the first DRX cycle and on a third paging occasion of a second DRX cycle in accordance with the paging collaboration configuration,
wherein the third paging occasion is associated with the first UE.

18. The method of claim 17, wherein operating in the low power mode for the portion of the first DRX cycle includes operating in the low power mode for a remaining duration of the first DRX cycle after the second paging occasion and for an entirety of the second DRX cycle.

19. The method of claim 17, wherein the paging collaboration configuration includes a common group identifier.

20. The method of claim 14, further comprising operating in a low power mode for a number of discontinuous reception (DRX) cycles in accordance with the paging collaboration configuration.
